(19) United States
(12) Patent Application Publication
(10) Pub. No.: US 2016/0188903 A1
(43) Pub. Date: Jun. 30, 2016

(54) CONTROLLING ESSENTIAL LIFE DATA

(71) Applicant: MYPERSONALDOCS PTY LTD, East Brighton, Victoria (AU)

(72) Inventors: Jason Michael WEBB, Windsor, Victoria (AU); Jeffrey Dennis LOEWENSTEIN, East Brighton, Victoria (AU)

(73) Assignee: Mypersonaldocs PTY LTD, Victoria (AU)

(21) Appl. No.: 14/911,142

(22) PCT Filed: Aug. 11, 2014
(86) PCT No.: PCT/AU2014/000801

§ 371 Date: Feb. 9, 2016

(30) Foreign Application Priority Data
Aug. 9, 2013 (AU) 2013903016

(51) Int. Cl. G06F 21/62

(52) U.S. Cl. CPC G06F 21/6245; G06F 21/6209

(57) ABSTRACT

A computer-implemented method for controlling essential life data including estate content to at least one user according to the respective user's predefined directions. The computer-implemented method includes receiving essential life data including estate content and recording as digital data; providing a secure digital storage for receiving and storing the digital data; receiving predefined directions data indicative of the predefined directions of the respective at least one user including identity of a trusted person; selecting predefined access specific data in accordance with predefined access parameters, including in relation to the predefined directions data providing the predefined access specific data in accordance with predefined access parameters to the trusted person and the at least one user. Accordingly the trusted person and the at least one user have access to the digital data from the secure storage according to the predefined access parameters.

### FIELD OF THE INVENTION

The present invention relates to holding, controlling and displaying essential life data and content and in particular to an off-line computer-implemented method, a server, and a computer readable storage medium for controlling essential life data including estate content.

The invention relates to a storage system for keeping personal documents secure. Furthermore, the invention relates to a process to support the collation of the data, the compilation of related documents and the dissemination of the materials if required under certain events.

The invention has been developed primarily for use in control of legal, financial and other life defining parameters and will be described hereinafter with reference to this application. However, it will be appreciated that the invention is not limited to this particular field of use.

### BACKGROUND OF THE INVENTION

Until now, no one has created a comprehensive list and process incorporated into a storage system to record all of the essential details, data and information required for individuals allowing for the recording of every aspect of a person's important and essential familial details, life-matters and investments—for the express purpose of simple retrieval in the event of the individuals incapacitation, death or property destruction.

Though some kits to assist individuals prepare a final will and testament exists, professional advisors advise against the use of these kits, advising that a final will and testament should be prepared by a legal practitioner to avoid confusion, inconsistencies and incompleteness during the execution of the will. More importantly, the existing kits do not cover the entirety of information (they only assist with a relative percentage of the total data and documentation) that will need to be retrieved by executor or legal representative to deal with the complex affairs left behind in event of an individual's death or incapacitation.

There also exists a few lists and articles outlining key documentation that should be stored in emergency condition but none are comprehensive and do not provide a process for recording, storing and dissemination the essential information when it will be needed.

The present invention aims to alleviate some of the issues described above by providing a specially designed container designed to secure specialized information and personal information forms and storage means that will not only secure the information, protect it and disguise its importance and minimize the effects of the atmosphere on the contents of the file. The invention furthermore provides instructions for a process for compiling and storing this information so as to make the invention effective in meeting the purpose of simple retrieval in the event of the individuals incapacitation, death or property destruction.

In recent times, it has been noted that having everything on line in the digital world is not in all cases a safe way of protecting data. In particular it is not clear when anyone or more of millions of interactions between digital storage devices is not an authorised access to data. Clearly there has been the development of firewalls and other protective mechanisms of this require consistent review and constant update of the protective mechanisms. By the greater and greater digital interrelationship of multitude of people and organisations it is no longer an applicable protection means to be focused against a common threat but necessary to be protecting against four possible threats from anywhere in the digital world. Statistically this becomes a harder and harder prospect.

However it is also not the appropriate mechanism to return to a completely non-digital world. The modern digital world provides a great way of creating data transmitting data storing data categorising data and making darker accessible for useful interactions in this world. Such advantages and disadvantages of digital world and such advantages and disadvantages of the non-digital world are required in the most important area of life essential data including estate content.

The invention seeks to provide a means for controlling essential life data including estate content to at least one user which will overcome or substantially ameliorate at least one or more of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

Preferably the present invention relates to displaying content and in particular to a computer-implemented method, a server, and a computer readable storage medium for controlling access to essential life data including estate content to at least one user or trusted person according to access parameters. This can relate to the predefined directions, or a combination of predefined directions with the user health status and user predefined event status, or other relevant factors.

In one form of the invention there is provided a computer-implemented method for controlling essential life data including estate content to at least one user according to the respective user's predefined directions, the computer-implemented method comprising: receiving essential life data including estate content and recording as digital data; providing a secure digital storage means for receiving and storing the digital data; receiving predefined directions data indicative of the predefined directions of the respective at least one user including identity of a trusted person: selecting predefined access specific data in accordance with predefined access parameters, including in relation to the predefined directions data: providing the predefined access specific data in accordance with predefined access parameters to the trusted person and the at least one user; wherein the trusted person and the at least one user have access to the digital data from the secure storage means according to the predefined access parameters.

Preferably the secure storage means is able to be made off-line. More preferably the secure storage means is connectable by USB and able to be disconnected and made off-line. In this way the secure storage means is storable in a secure remote location.

The computer-implemented method can include a digital key wherein the digital key provides the predefined access specific data in accordance with predefined access parameters. Preferably the secure storage means is also the digital key.

The access parameters can include, in relation to the predefined directions data, a combination of one or more access parameters including user health status and user predefined event status.

Preferably the access parameters includes in relation to the predefined directions data and a combination with one or more other access parameters including identification of trusted person data, wherein a modified predefined directions specific data is available.

Preferably the access parameters includes in relation to the predefined directions data and a combination with one or more other access parameters including Emergency condition, wherein a modified predefined directions specific data is available.

The computer-implemented method can further comprise making available the predefined directions specific data to the at least one user or trusted person according to the access parameters including the predefined directions data.

Preferably the method further comprises the predefined directions specific data being received by the server selecting and providing via the input/output interface to the at least one user or trusted person.

Preferably the method further comprises the predefined directions data being included in the database and the at least one user or trusted person can select the predefined directions specific data from the database.

The computer-implemented method can further comprise outputting the predefined directions specific data to a display device for displaying to the at least one user or trusted person.

Preferably the predefined directions data is received from a digital key.

Preferably the predefined directions access key comprises a Smart card or similar. The predefined directions access key can comprise a USB reader for reading USB tag data.

In the computer-implemented method the predefined directions access key can be adapted to determine the predefined directions of the at least one user from their access parameters.

Preferably the predefined directions access key is adapted to determine the predefined directions of the at least one user from their access parameters and predefined user health status and user predefined event status.

Preferably calculating predefined directions specific data comprises receiving the predefined directions data via a data network interface.

The computer-implemented method can further comprise receiving identification data indicative of at least one content provider; and verifying the identity of the at least one content provider as a registered content provider in accordance with the identification data.

A computer-implemented method as claimed in any one of the preceding claims, further comprising receiving statistical data indicative of the number of the at least one users receiving the predefined directions specific data; and revising the data in accordance with the statistical data.

A computer-implemented method as claimed in claim 19, further comprising sending the statistical data to at least one content provider.

A computer-implemented method as claimed in claim 19, further comprising updating the data via the at least one database connection in accordance with the revised data.

In accordance with another aspect of the invention there is provided a server for controlling essential life data including estate content to at least one user according to their predefined directions, the server comprising: a processor for creating and collating essential life data including estate content according to computer program code and processing into digital data; a memory device for storing the computer program code and being coupled to the processor via a bus; a data network interface for sending and receiving the digital data according to the computer program code to a removable secure digital storage means and being coupled to the processor via the bus; at least one database connection for retrieving the digital data including the essential life data including estate content from the removable secure digital storage means, wherein the processor is controlled by the computer program code to: receive predefined directions data indicative of the predefined directions of the respective at least one user including identity of a trusted person; receive selected predefined access specific data in accordance with predefined access parameters, including in relation to the predefined directions data provide the predefined access specific data in accordance with predefined access parameters to the trusted person and the at least one user; wherein the trusted person and the at least one user have access to the digital data from the secure storage means according to the predefined access parameters only according to the predefined directions and the predefined access parameters.

Preferably the processor is further controlled by the computer program code to provide, via the data network interface, the predefined directions specific data to the at least one user in accordance with access parameters, including in relation to the predefined directions data.

The processor can be further controlled by the computer program code to allow the secure storage means to be made off-line.

The processor can be further controlled by the computer program code to connect with the secure storage means by USB and able to be disconnected and made off-line.

Preferably the processor is further controlled by the computer program code to store the digital data in the secure storage means which is storable in a secure remote location.

The server preferably includes a digital key wherein the digital key provides the predefined access specific data in accordance with predefined access parameters. More preferably the secure storage means is also the digital key.

The processor can be further controlled by the computer program code to: access parameters includes in relation to the predefined directions data and a combination with one or more of other access parameters including user health status and user predefined event status wherein a modified predefined directions specific data is available.

The processor can be further controlled by the computer program code to access parameters includes in relation to the predefined directions data and a combination with one or more of other access parameters including Identification of trusted person data wherein a modified predefined directions specific data is available.

The processor can also be further controlled by the computer program code to access parameters includes in relation to the predefined directions data and a combination with one or more of other access parameters including Emergency condition wherein a modified predefined directions specific data is available.

Preferably the processor is further controlled by the computer program code to further comprising making available the predefined directions specific data to the at least one user according to the access parameters including the predefined directions data.

The invention provides another form a computer readable storage medium for controlling essential life data including estate content to at least one user according to their predefined directions, the computer readable storage medium comprising computer program code instructions recorded thereon, the computer program code instructions being executable by a computer and comprising instructions for receiving, via a data network interface, predefined directions data indicative of the predefined directions of the at least one user; and selecting, using via at least one database connection, predefined directions specific data in accordance with the predefined directions data.

The computer readable storage medium further comprises instructions for sending, via the data network interface, the predefined directions specific data to the at least one user.

Preferably the computer readable storage medium further comprises instructions for outputting the predefined directions specific data to a display device for displaying to the at least one user, wherein the predefined directions data is received from a predefined directions access comprises a Smart card. The predefined directions access key can be adapted to determine the predefined directions of the at least one user from their access parameters. Preferably the predefined directions access key is adapted to determine the predefined directions of the at least one user from access parameters and predefined user health status and user predefined event status.

The invention further provides a client computing device for controlling essential life data including estate content to at least one user according to their predefined directions, the client computing device comprising: a processor for processing digital data; a memory device for storing digital data including computer program code and being coupled to the processor via a bus; and a data network interface for sending and receiving digital data and being coupled to the processor via the bus, wherein the processor is controlled by the computer program code to: send, via the data network interface, to a server, predefined directions data indicative of the predefined directions of the at least one user; and receive, via the data network interface, predefined directions specific data from the server, the predefined directions specific data being selected by the server according to a comparison of data and the predefined directions data.

Preferably the processor is further controlled by the computer program code to: send, via the data network interface, the predefined directions specific data to the at least one according to access parameters.

The processor can be further controlled by the computer program code to: provide access parameters including in relation to the predefined directions data and a combination with one or more of:

User health status and user predefined event status
Identification of trusted person data
Emergency condition
wherein a modified predefined directions specific data is available.

It can be seen that the invention provides a software interface and secure storage utility, that can work remotely from web and cloud and server and mobile or other transmission technologies, and facilitates and then automates a closed loop of connected human trusted persons back to the software and its contents, via user opt-in permissions, to permit them entire or partial access to either the physical software, a duplicate encrypted file, and its contents under certain events and/or timeframes, thus ensuring the information cannot be lost or forgotten.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic view of a system for controlling life essential data including estate content in accordance of a general embodiment of the invention;

FIG. 2 is an illustrative diagrammatic view of the multitude of world interactions that a person is involved and therefore forms the great quantity of life essential data including estate content;

FIG. 3 is an illustrative diagrammatic view of the general sections of a system for controlling life essential data including estate content in accordance of a general embodiment of the invention;

FIG. 4 is an illustrative diagrammatic view of the function in a digital and non-digital world of a system for controlling life essential data including estate content in accordance of a general embodiment of the invention;

FIG. 5 is a diagrammatic view of a system for controlling and composing and collating life essential data including estate content in accordance of a general first embodiment of the invention;

FIG. 6 is a diagrammatic view of a system for controlling life essential data showing the interaction of people in the communication system and their interaction with the users life essentials in the controlled off-line means;

FIG. 7 shows a computing device on which the various embodiments described herein may be implemented in accordance with a preferred embodiment of the present invention with the key access is connected and controlled over a communication network;

FIG. 8 shows a computing device on which the various embodiments described herein may be implemented in accordance with a preferred embodiment of the present invention with the key access is connected directly;

FIG. 9 is a flowchart of the interaction and control by the computing device on the essential life data if certain criteria permissions are satisfied;

FIG. 10 shows a physical system for controlling life essential data including estate content in accordance of a general first embodiment of the invention;

FIG. 11 is a perspective view of the container with its lid open of the physical system for controlling life essential data of FIG. 10;

FIG. 12 is an overhead view of the ring binder with the storage means attached and includes a close-up view of the spine of one of the storage means of the physical system for controlling life essential data of FIG. 10;

FIG. 13 is a front view of each of the storage means supplied in the container of the physical system for controlling life essential data of FIG. 10;

FIG. 14 is a general flow diagram of the computer-implemented method for controlling essential life data including estate content to at least one user according to the respective user's predefined directions;

FIGS. 15 and 16 are illustrative components of the system of essential life data;

FIG. 17 is a computer screen page of interactive forms that can be accessed to provide instructions and collection of categories of essential life data;

FIG. 18 is a computer screen page of the allocation of trusted person together with details of the position locator of the off-line data key;

FIG. 19 is an illustrative example of an element of the security access the data key by password connection;

FIG. 20 is an illustrative example of an update mechanism that the user can apply to update the data key and collation of life essential data to create a new master file that forms you key and data;

FIGS. 21 and 22 show illustrative examples of the control and interaction with trusted persons that occurs such as shown in the system of FIG. 6 while being disconnected to the off-line data and activation key;

FIGS. 23 and 24 show illustrative examples of the instruction provided by the controlling software such as collecting birth certificate and the storing of that essential life data; and

FIGS. 24 and 25 further illustrative examples of controlling software such as inflation of photos or other documents forming other parts of the essential life data.

### DESCRIPTION OF EMBODIMENTS

It should be noted in the following description that like or the same reference numerals in different embodiments denote the same or similar features.

Referring to the Figures, the invention includes a method, system and computer aided method of holding, controlling and displaying essential life data and content and in particular to an off-line computer-implemented method, a server, and a computer readable storage medium for controlling essential life data including estate content.

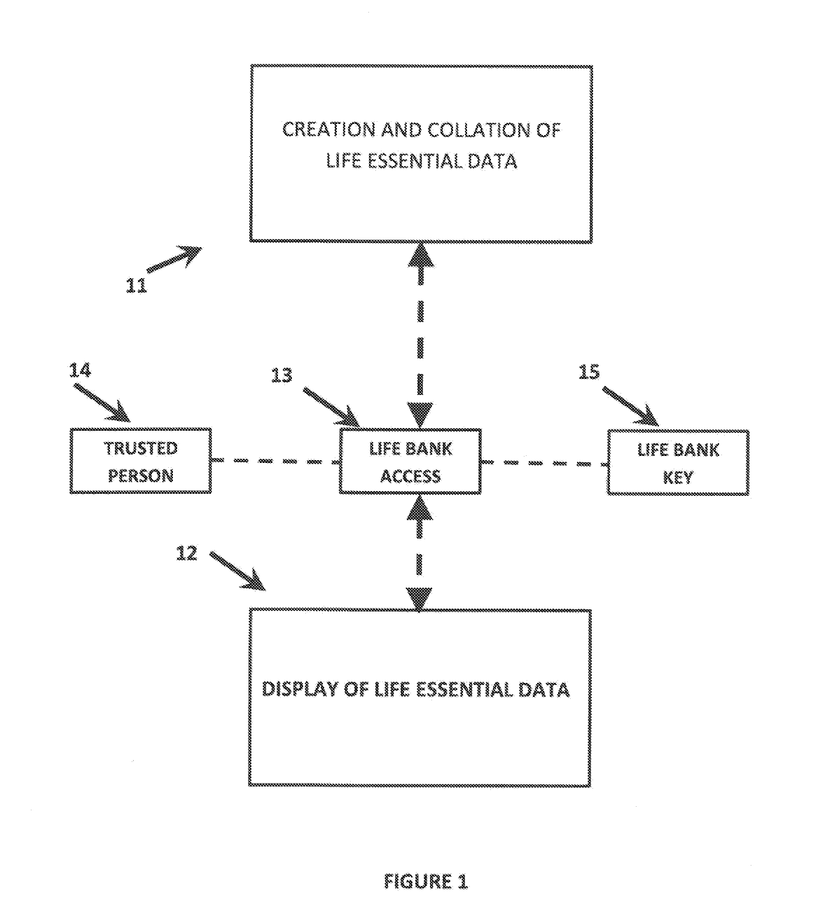

Referring to FIG. 1 very shown the fundamental arrangement of the life essential data system which limits the display of life essential data 12 after it has been created and collated by the system of life essential data 11. However there is a communication and online aspect of the invention which includes the creation of inflation of life essential data 11 but there is the off-line aspect of the invention which precludes access to the display of life essential data 12 unless there is that the life essential access 13 instituted by the trusted person 14 or user by use of the life essential key 15.

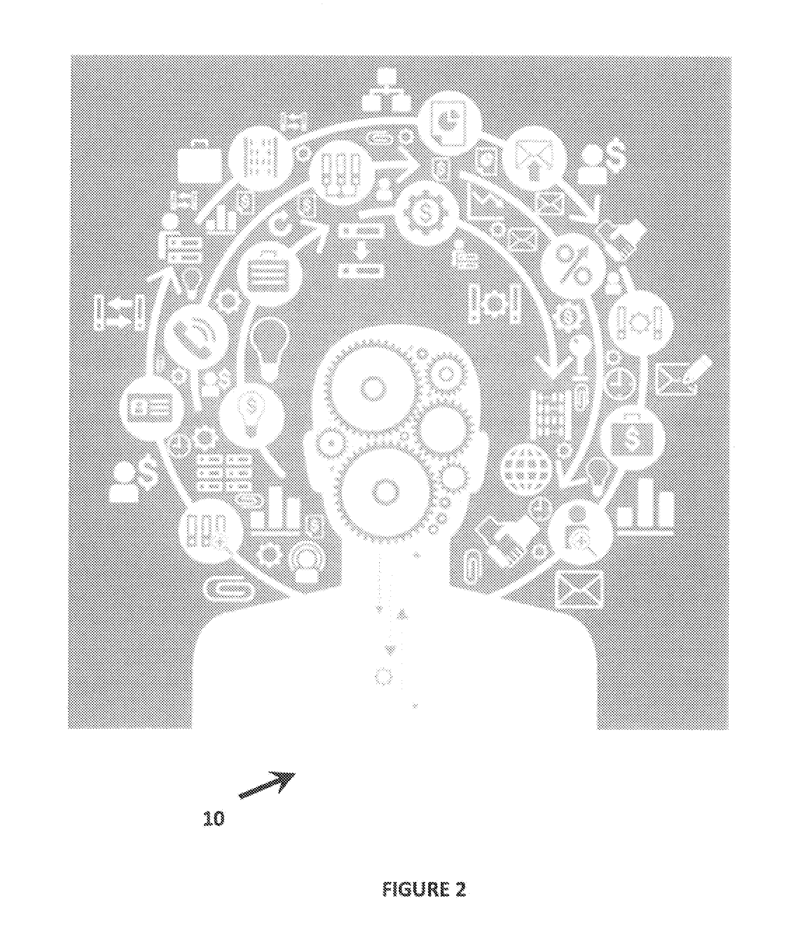

In FIG. 2 it is shown by illustration actions and reactions and interactions that a person has in life which goes to form a substantial quantity of personal data of forms a user's essential life data. It is due to this substantial quantity and need for organisation and collation to a logical format that is not possible to merely collect. It is therefore an important aspect to be able to control and instruct and lead the user in the collection and creation of this life essential data. Therefore the invention also provides a method for compiling the information and documents and keeping them secure and easy to retrieve. It may be appreciated that whilst this document may describe the invention with respect to such use, the scope of the invention is not limited to use of simple retrieval in the event of the individuals incapacitation, death or property destruction.

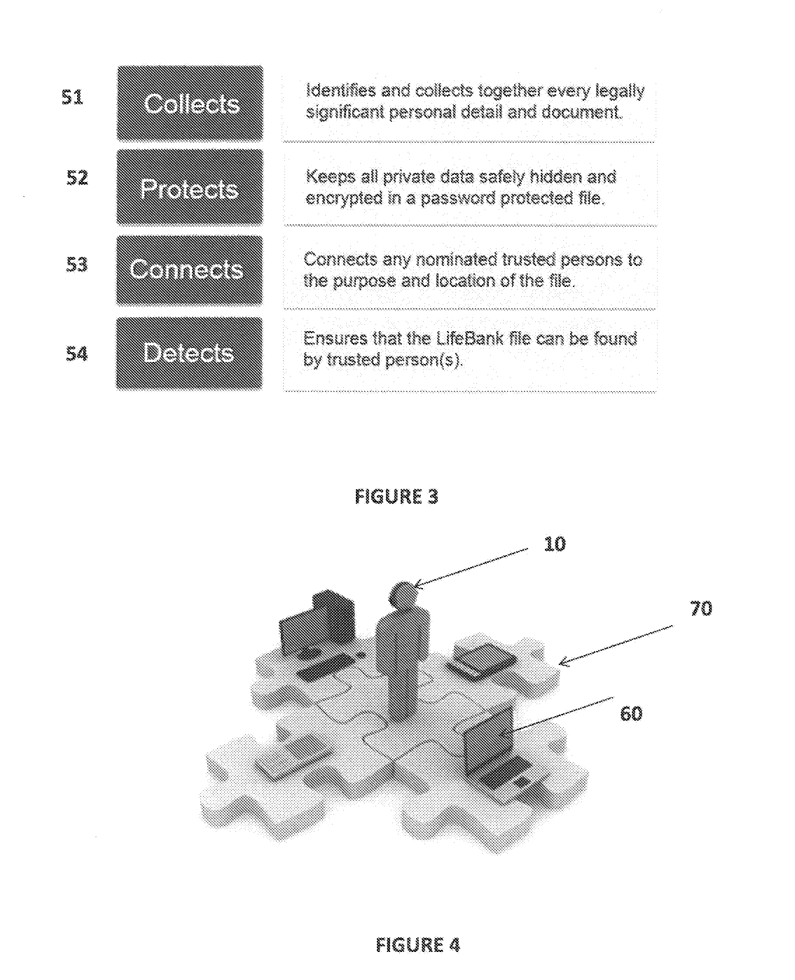

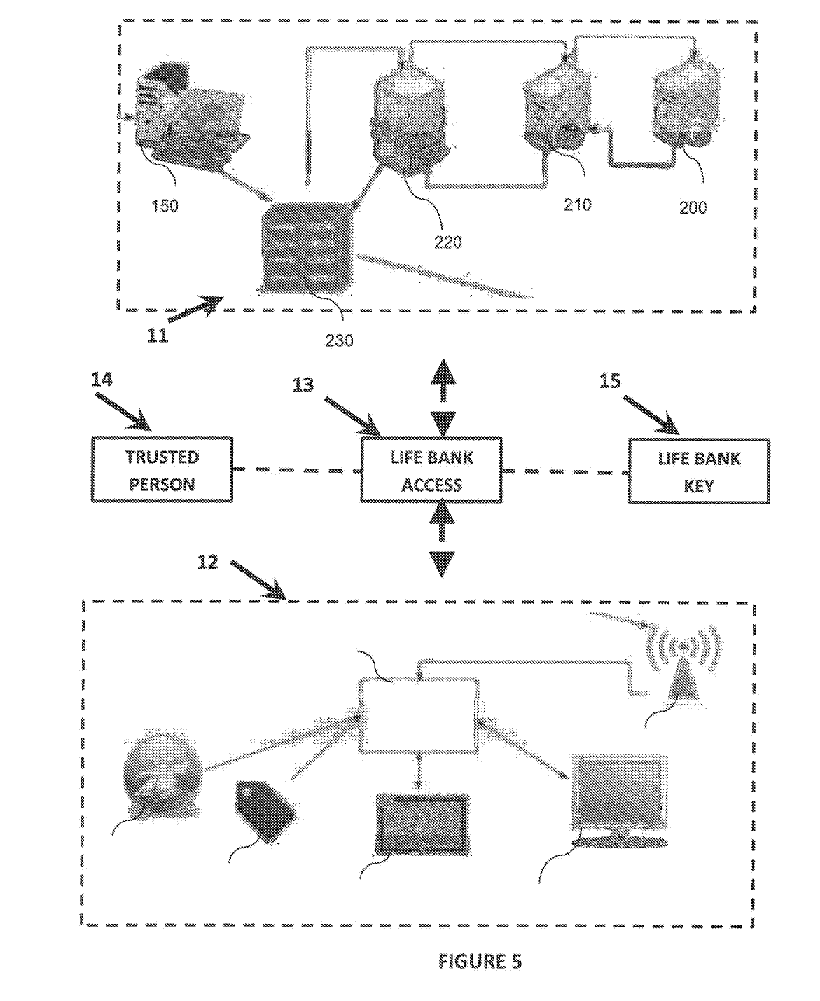

As shown in FIG. 3, by a combination of collection, protection, connection and detection. In the step 51 of collection is the identification of collection together and therefore the collation of every legally significant personal detail and document that can be said to create the essential data of a person. This essential data can also include estate content in which at the time of death of the person a range of essential data is made available. However the user, prior to the particular health status or death or event status, generally wishes to control the access to such information.

In the step 52 of protection, all of the essential data is safely hidden and encrypted to prevent access by anyone that the user has not authorised.

To fulfil such control of access is necessary to include step 53 of connection in which only nominated trusted persons are connected to the purpose and location of the file. This location element of the invention is important because the system is primarily off-line and the physical key or data file can be further controlled by its location and knowledge of location.

In the further step 54 is now no protection to ensure that the essential data file can be found by the trusted person access is provided to that data.

Referring to FIG. 4 there is an illustrative view the person 10 can be selectively connected to the on-line digital world 60 including laptop computers 61 notebooks 62, personal computers 63, and hand-held smart devices 64. Generally the essential part of a person 60 is also connected to this digital world. However such connection to the digital world opened up the access through authorised or not authorised ways by a multitude of other connected persons or organisations. Therefore in the same way that the person 10 can be selectively disconnected to the digital world and be in the off-line non-digital world 70. The collation of essential data of the person 10 can also be selectively disconnected to the digital world. As shown by the interlinking physical elements 71, 72, 73, 74, 75 in the off-line non-digital world 70 the person 10 can still be connected but in the physical and non-digital world. The essential data system of the invention can make use of this selective connection to the digital world and use of the interconnection in the physical world.

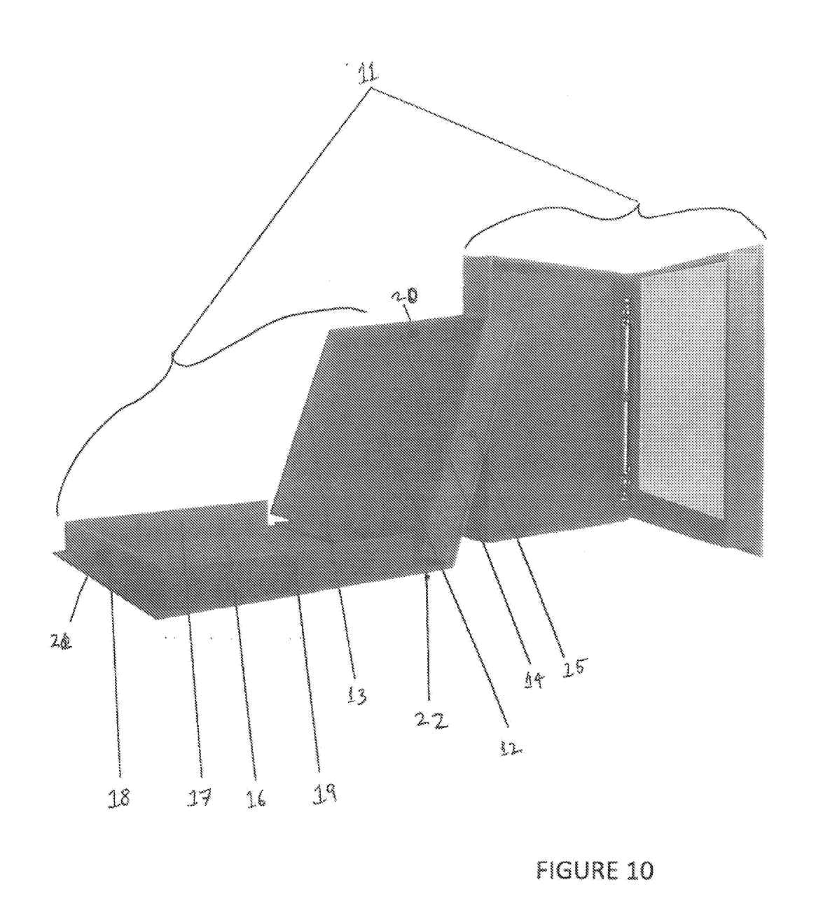

Referring to FIGS. 10 to 13, this embodiment of the invention is primarily a storage system for keeping important essential life data, including personal information and documents, secure for the purpose of simple retrieval in the event of the individual's incapacitation, death or property destruction. However, the invention is not limited to these fields of use. It may also be useful for maintaining important information of a company, property or any legal personnel for easy retrieval in the case of emergency condition or transfer of ownership.

There is provided a storage system for maintaining in a secure manner a person's personal information to be readily accessed and used in the event of the person's incapacitation, death or property destruction.

Preferably, the storage system may be in the form of a container that has a solid box buckram and/or cardboard structure.

Preferably the life essential data of personal information comprises important information and documents relating to the person's assets and how these assets should be distributed in the case of incapacitation, death or disappearance. This important information and documents could relate to the person's will, related powers of attorney, account details, insurance policies, broker accounts, property deeds, mortgages or other related information or documents.

Optionally the life essential data on personal information comprises important information and documents relating to the person's medical history, health insurances or other related information and documents.

Optionally the life essential data on personal information comprises important information and documents relating to the person's computer and online accounts, passwords, user ids or other confidential information.

Optionally the life essential part of personal information comprises important information and documents relating to the person's identification such as marriage certificates, birth certificates, passport, driver's license or other related information and documents.

The storage system may optionally be in digital form on a secure storage medium such as a remote medium accessible through the internet, a USB drive or an external hard drive.

Preferably, the storage system comprises a correlation of the life essential data of personal information related to specific types of information, documents or copies of documents including but not limited to:
Investments
Mortgages
Property deeds
Prepaid funeral arrangements
Final will and testament
Insurance policies
Certificates of birth or marriage
Other personal information or documents

The storage system may also contain means to support the compiling the life essential personal information or documents including:
Prepared templates
Sleeves or envelopes
Checklists
Guidelines for completing the information to be contained therein

Preferably the prepared templates and guidelines may be available in preprinted form. Alternatively, the templates and guidelines may be provided in digital form on the Internet. The templates and guidelines may also be downloaded from the Internet.

Optionally the storage system may contain an authentication device to prevent unauthorized access, wherein the authentication device could include key, secure code, biometric means, password or other means to secure the personal information from unauthorized access.

The container used in the storage system may also be resistant to:
Fire
Water
Decomposition
Other environmental factors able to cause the compromising of the information or documents.

The container used in the storage system may optionally be disguised to discourage theft. The invention also comprises a method for compiling a person's personal information comprising the following steps: collecting the important personal information and related documents, identifying a trusted person and recording their details; and storing the personal information and related documents in a secure predefined directions.

Optionally this method also comprises a step to notify the trusted person, wherein the invention provides means to inform the person of the compilation of the personal information and how to access it.

The invention may also comprise a checklist to ensure that the person using the storage system completes steps involved in this method.

In order that this invention may be more easily understood and put into practical effect, reference will now be made to the accompanying drawings, which illustrate a preferred embodiment of the invention, wherein the storage system is realized as a physical container. It is also understood that other embodiments may comprise information and documents being stored in digital form. However the preferred embodiment is considered superior because it allows the user to retain greater control over the security and storage predefined directions. A physical container also makes it possible to include physical documents and items such as a signed will, marriage and birth certificate, certificates, passport, bank deposit keys, safe keys, other official documents, other signed original documents and other related items or documents.

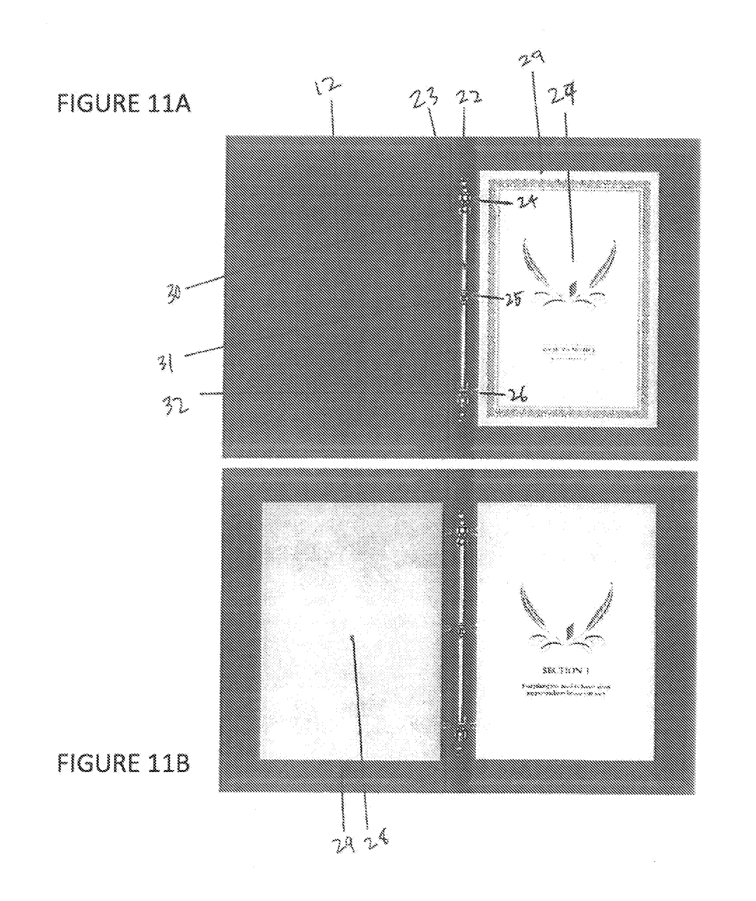

Referring to the FIG. 10, there is shown a container 1 with a lipped clamshell design. The container has dimensions of 35 cm in length by 28 cm in width by 5.5 cm in height. The container 11 has a lid 12, which has sides 13, 14 and 15. The container also has a base 16 with sides 17, 18 and 19 such that when the lid 12 is folded down to close the container, the sides 17, 18 and 19 are contained within sides 13, 14 and 15 respectively thereby providing an internal environment inside the box which is sealed from outside environment which helps minimize deterioration of the contents. The container's principal purpose is to keep a collection of storage means, envelopes and sleeves (shown in FIGS. 11, 12, and 13) securely in one place—and also for ease of storage and handing across to a third party for safekeeping.

The material of the box is preferably made of a material (buckram or cloth) covered firm cardboard which is durable and sturdy but still relatively light to make for easy handling. This material is also advantageous in that it provides resistance to moisture and dust. Furthermore, the material is also of a high quality finish so that anyone finding the container will immediately understand that it contains something of value. On the other hand, the container has such significant markings so as to be discrete to minimise potential for recognition by unwarranted users.

In order to facilitate the protection of the contents, the lips of the box close together to form a near airtight seal to minimize atmospheric deterioration of the contents. The spine 22 connects the base 16 with the lid 12 such that the spine 22 is not connected to the sides 13 and 15 of the lid 12 nor to the sides of the base 17 and 19. By this means, the spine 22 forms the 4th side of the container.

In addition, in FIG. 11a it can be seen that mounted on the spine 22 is a ring binder 23 for attaching storage means in such a manner that when the lid 12 is opened, the spine 22 lies flat and a storage means 29 can be easily flipped over, from a flat position with its front page 27 facing up to a flat position with its back cover 28 facing up (FIG. 11b). The ring binder 23, uses twin rivets 30, 31, 32, which are stronger, easier to open with fingers, and larger for the number of storage means provided.

Each storage means is bound in a saddle stitched manner and has 3 loop stapes 24, 25 and 26, protruding from its spine whereby loop staples 24, 25 and 26, are used for connecting each storage means to the ring binder 23, and to facilitate the smooth flipping of the storage means from a front facing positing flat on the base, to a back cover facing position flat on the lid.

The rings 30, 31, 32 of the ring binder 23 can be opened such that each of the loop staples 24, 25, 26 of the storage means can be connected into the open rings of the ring binder. The rings 30, 31, 32 can then be closed so that the storage means can be retained securely attached within the container but with the freedom to flip them over from a front facing position to a back facing position.

Loop staples are used instead of having holes punched into the storage means as is common in ring binders so that the storage means can be easily opened, the pages flipped through without having to remove them from the binder. The use of these staples also minimizes damage to the storage means when removing them or replacing them in the container.

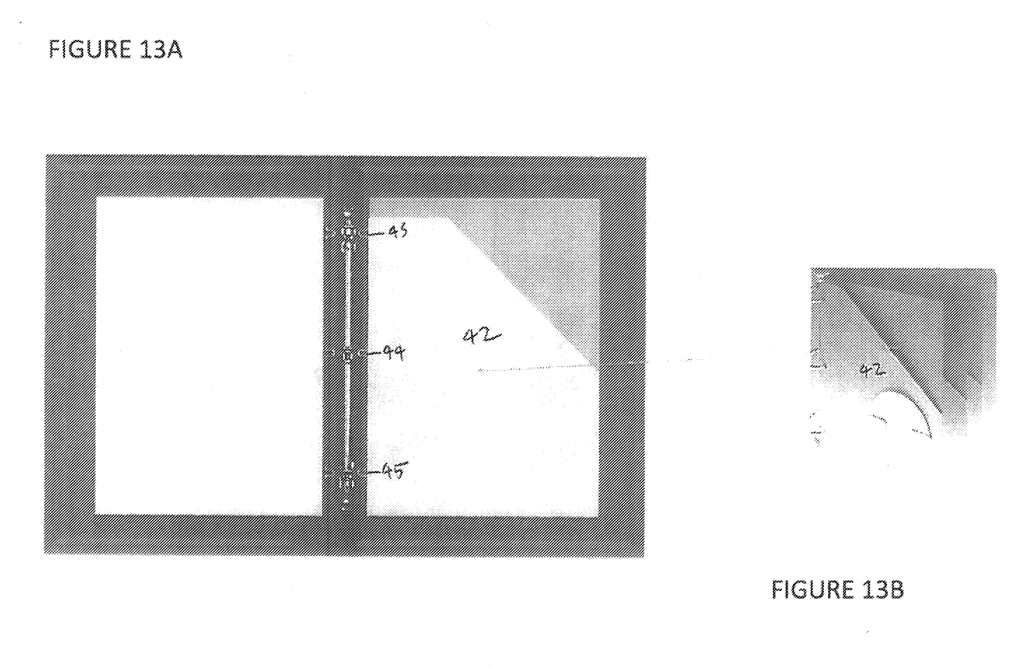

Similarly, as shown in FIG. 13a and FIG. 13b sleeves 42 or alternatively envelopes (not shown), supplied for keeping valuable documents within them, are attached with loop staples 43, 44, 45, so as to minimise the chance that the rings of the ring binding system damage the documents contained therein.

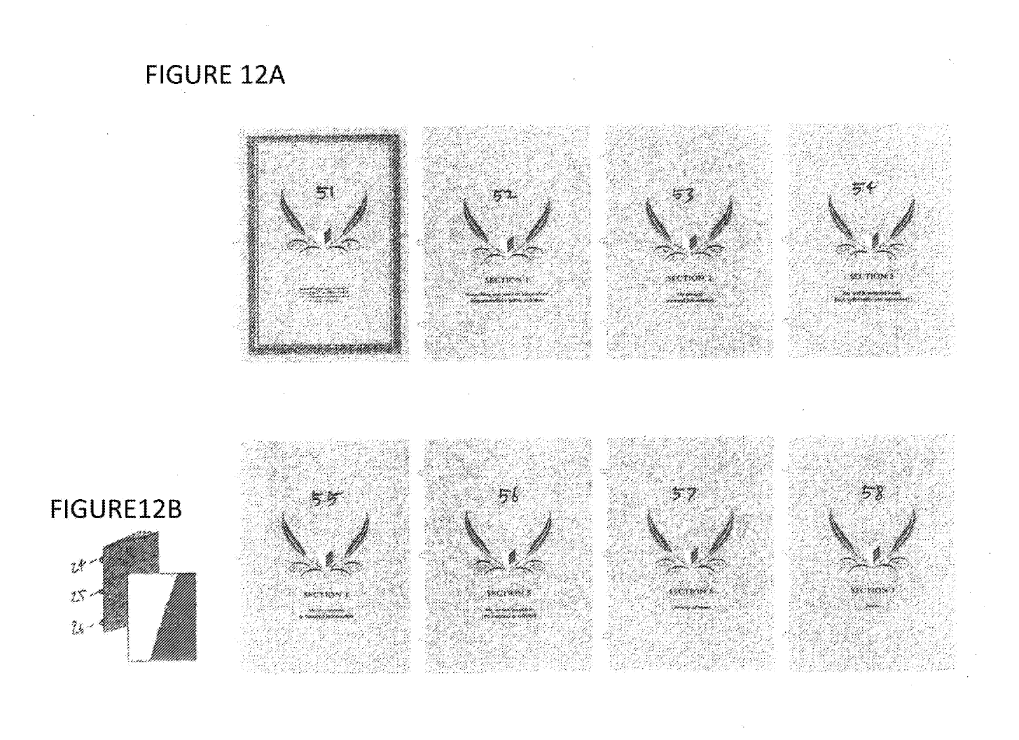

FIG. 12 describes 8 examples of storage means 51 through 58 to be supplied with the container. Each of the storage means is produced from archival paper with a life of up to 50 years to maximise potential for documents remaining legible for many years to come.

The container provides for information to be collected in multiple storage means. As such the storage means are distinguished by the type of information recorded therein, in anticipation of the owner's need to separate out certain information to facilitate taking out one or more individual storage means while they work on compiling the related information or if they need to pass on specific information to a third party for reference or safekeeping.

In the preferred embodiment, the storage means comprise:
A storage means 51 containing forms for recording the identity of the owner of the container, the identity of the trusted person and the information contained therein. It would also contain forms for recording information including but not limited to that relating to the individuals to be entrusted with the container and its contents. This storage means may also contain a summary of the contents of the container including other storage means, and documents included in envelopes or sleeves.
A storage means 52 providing checklists, instructions and other information for using the container and the storage means contained therein.
A storage means 53 containing forms for recording personal information (together with advice relating to their use) including but not limited to information relating to the owners family, medical history, medical insurance, prenuptial agreement, tax file numbers, family trusts, passports, drivers licenses, car registrations, wills, funeral arrangements, burial wishes and other related information.
A storage means 54 containing forms for recording information (together with advice relating to their use) relating to the owner's personal and real essential life data including estate including but limited to information relating to the owner's home and properties such as title deeds, mortgages, insurances, and valuations.
A storage means 55 containing forms for recording information (together with advice relating to their use) relating to the owners finances and investments including but not limited to information such as bank accounts, safety deposit boxes, superannuation funds, credit cards, investments in cash, shares, bonds or other instruments, loans, and trusts. This storage means may also contain other related information such as court judgments, bankruptcies, and the owner's employment history.
A storage means 56 containing forms for recording information (together with advice relating to their use) relating to the owner's services-providers including both professional and utilities services. This information could include but is not limited to details of providers of legal, accounting, financial planning and stock braking services; providers of electricity, gas, water, telephone, cleaning and garden services.
A storage means 57 containing forms for recording confidential information (together with advice relating to their use) including but not limited to details of various online accounts, email addresses, credit cards. PIN numbers and computer login identification and the related passwords. This may also include detail of computers and digital storage devices containing important or confidential information. This storage means may also be provided in the form of a sealable sleeve or envelope to prevent unwanted access. The sleeve or envelope could be adapted to secure the information in written form on paper or in secured digital form on a CD, USB stick or other similar storage device.
A storage means 58 containing forms for recording information relating to the owner's heritage and legacy including but not limited to information relating to the owner's family tree, life stories, important memories, family treasures and other similar information.

There may also be supplied other storage means including but not limited to the following list:
A storage means containing forms for recording information that does fit in within the type of information recorded in the other books.
A storage means containing a glossary of terms and other supporting information on how to use the container and the storage means.
Checklists of items and steps to be undertaken by the user of the invention.
Information related to legal requirements, rights and remedies.

Additionally, the container may be supplied with materials such as one or more cards in the form of a mailing card, designed to be sent to a trusted person, informing them of the fact that all of the owners essential documents have been compiled in a single secure predefined directions and letting them know where that information is being stored and how to access it in the case of the owner's incapacitation, death and/or property destruction.

Similarly, the container may also provide for one or more wallet or pocket-sized cards containing information on next of kin, executors or trusted persons who have access to the container and its contents. These cards being designed to be kept on the owner's person in the case of their premature incapacitation, death and/or property destruction.

Additionally, the container will also comprise a number of C4 storage envelopes to allow the user to place the storage means and or other documents in and seal for additional protection and/or privacy.

The box will also house a proforma letter designed to be sent to a nominated Trusted Person alerting them to the storage folders existence and one or more Emergency condition Cards for the user to keep in their possession to alert other concerned parties in the event something was to happen to the user.

The process for the owner or other related person's to use the invention can also be described as follows:
Upon opening the container, the owner is required to nominate one or more Trusted Persons to be the custodian of the container and its contents in certain events (namely upon death or incapacitation of the owner).
The owner writes down the required details of the Trusted Persons (custodian/s) in the first storage means provided (51).
The owner writes down the required details of the Trusted Persons (custodian/s) as well as their own details, on the Emergency condition Wallet Cards provided and stores cards in their purse, wallet or other suitable personal place.
The owner also writes down his/her own details on the AS Trusted Persons card provided and mails/sends the card to the nominated Trusted Person/s, notified and provide instruction
The owner writes down the details they require to be recorded as instructed in the different Section information and form storage means (51-58) provided.
The owner uses the Final Checklist to ensure the information and process has been completed correctly.
The owner may then place each or any of the Section Storage means into a C4 envelope provided for additional privacy.
The owner must also source, identify and secure any other external important documents as instructed in the Section Storage means (that they wish to also store in the container) and place them in the box.
The owner may place any of these documents in the supplied C4 envelopes if they desire.
The owner applies the relevant Label stickers supplied to the front of the envelopes, identifying the contents of each envelope.
Once complete, the owner places the supplied pro-forma A4 letter to their Trusted Person on top of all contents in the box.
The owner also places the 2× provided Info Sheets immediately beneath the A4 letter.
The owner then sends/posts the provided AS Trusted Persons Notification Card that has been completed and sealed in a C5 envelope (also provided) to their Trusted Person/s.
The owner follows up the correspondence with a phone call or meeting with the Trusted Person to discuss the arrangements of for the personal information and the container securing it, its storage predefined directions, any access issues (passwords, keys etc.) and handling.
The owner seals the container with all contents and places it securely in a determined ‘safe place’. This ‘safe place’ would most likely have been discussed with their Trusted Person.
The owner may periodically choose to update the contents of the container as required.
Upon the death of the owner (or upon incapacitation), the Trusted Person (custodian) will retrieve the container and its contents and respectfully enact upon the contents of the container as required on behalf of the Owner or the essential life data including estate.

It will of course be realised that the above descriptions have been given only by way of illustrative example of the present invention and that all such modifications and variations thereto as would be apparent to persons skilled in the art are deemed to fall within the broad scope and ambit of this invention.

As shown in FIG. 3, the essential life data system uses 4 technical levels of security—
encryption,
password,
registered email,
plus an application licence key.

The software on the device uses native encryption and also allows the user to create a multi-character password protection, linked to a live email account to secure the application.

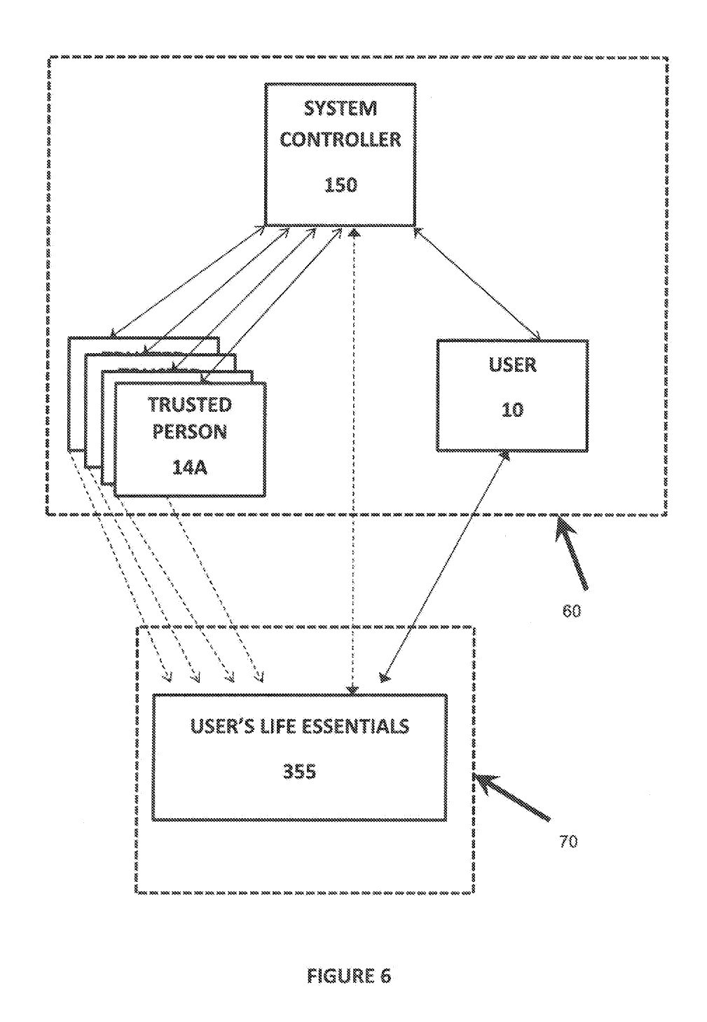

Referring to FIG. 6 the life essential data system is a secure software system that sits on a standalone storage device 355 designed to protect important, private and irreplaceable data by specifically linking together an individual software user 10 to a trusted advisor 14 and (at least one of) nominated trusted person(s) 14A, 14B, 14C, 14D from the individuals personal network to ensure the transfer of this important data to the nominated trusted advisor or trusted person(s) (in event of death or incapacitation or inability of the individual to access their data under a variety of predetermined circumstances).

The trusted parties 14A, 14B, 14C, 14D are all connected to the life essential data system software user 150 in the on-line digital world 60 via the functionality of life essential data system software. The connection to the off-line non-digital world 70 including the physical location of the physical storage device is not readily accessible without permissions.

Each trusted person 14A. 14B, 14C, 14D (and/or advisor 150) is permitted a portion of information (determined primarily by the user 10 and the function of the software) that when ‘connected together’—will enable one to
find the user's Life essential data system software's physical storage device 355, and/or
the Life essential data system software back up file, and then
gain access to its private contents—based on the permissions they have been given by the user (and via the life essential data system software documented permission provisions).

The life essential data system software also automatically updates the user's nominated Trusted Person(s) 14A, 14B, 14C, 14D with any changes to the location or the access information required (password/email address) to open the Life essential data system software. This ensures that the important information the user wishes to protect (for their estate or family or themselves) can remain private until the user determines it shouldn't remain private—and then only revealed to the Trusted Person and/or Trusted Advisor. Still further a “ping” code can apply only when the key is attached so that the system controller 150 can ensure there is valid access occurring and not forced tampering. However the system controller does not have access to the essential life data unless access permission given.

The life essential data system is a private, secure system for individual users that helps them identify all of their important data and documents, and collects these important data documents and then protects them all in an offline environment via a software application that has been designed to operate only on a standalone platform (such as: USB, Bluetooth, data key, external hard drive and other non-web connected computer or mobile devices).

The software application is designed to be fully interactive and updateable, and uses a customised interface, that allow users to enter important private data, encrypt their data (details, documents, files, photos, all electronic files) and then protect access to this data via a password and email identification front end.

As the software application secures entered data and saved files onto a standalone platform (i.e. it does not load private data onto to a computer or a server or a website or via cloud storage), the user can manage and store and transport their own private data, or store it without any exposure to any unwanted external access or hacking threat from web based or cloud or server based or transmission based backend.

The software application can only be opened by someone who has been given access to the life essential data key including the password and email identification. The files are hidden in the matrix of the software application and cannot be extracted without having access to the password, the email ID and access to the physical software application on the standalone platform.

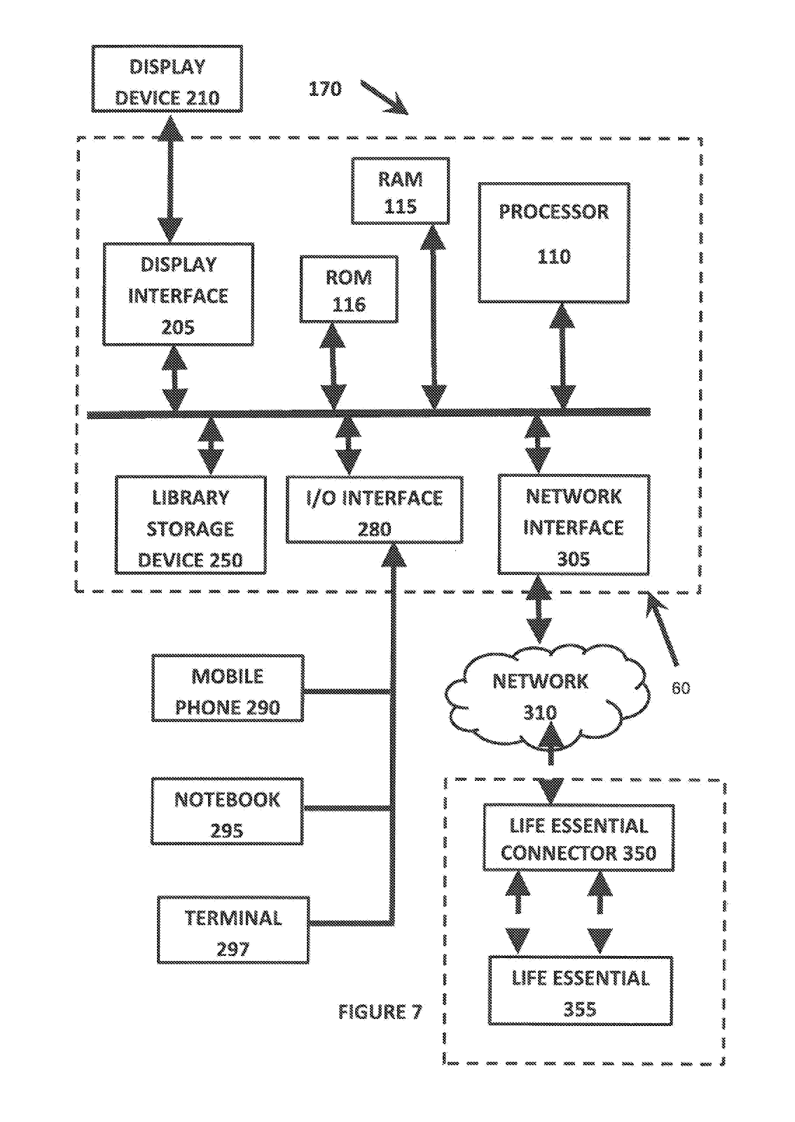

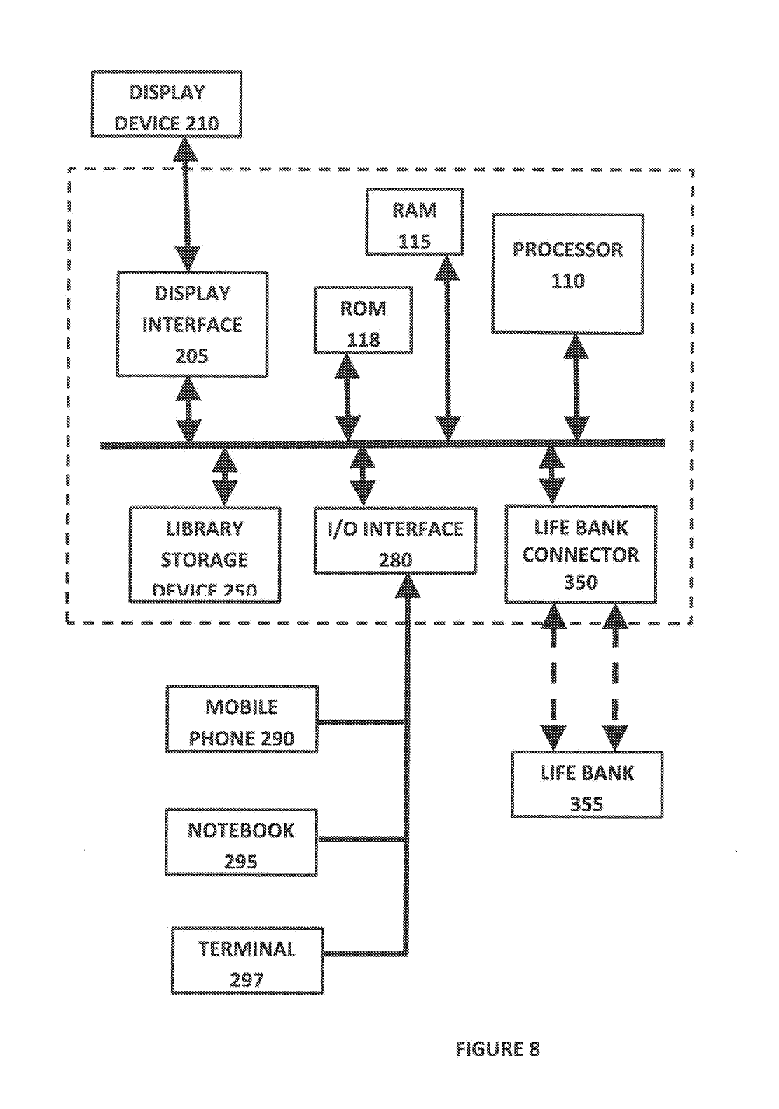

Referring to FIGS. 7 and 8 there is shown a server 170 of a trusted person 14A. 14B or 14C for controlling essential life data including estate content to at least one user according to their predefined directions. This server 170 provides the function of checking the access permissions of the trusted person 14A, 14B or 14C for accessing and displaying the life essential data on the secure storage device 355.

The server 170 in FIG. 7 comprises a processor 110 for creating and collating essential life data including estate content according to computer program code and processing into digital data. A memory device 115, 116 is for storing the computer program code and being coupled to the processor via a bus.

A data network interface 305 is for sending and receiving the digital data according to the computer program code which itself is on the secure digital storage means 355 and being coupled to the processor via the bus. At least one database connection 305 is for retrieving the digital data including the essential life data including estate content from the removable secure digital storage means 355. However effectively no user entered data ever leaves the USB—unless the user chooses it to, via backing up the file or storing an encrypted version of file outside of the USB.

Therefore in use the processor is controlled by the computer program code on the secure digital storage device 355 to
receive predefined directions data indicative of the predefined directions of the respective at least one user including identity of a trusted person 14A, 14B or 14C;
receive selected predefined access specific data in accordance with predefined access parameters, including in relation to the predefined directions data provide the predefined access specific data in accordance with predefined access parameters to the trusted person 14A, 14B or 14C and the at least one user 10.

In this way the trusted person 14A, 14B or 14C and the at least one user 10 have access to the digital data from the secure storage means according to the predefined access parameters only according to the predefined directions and the predefined access parameters.

Preferably the processor is further controlled by the computer program code to provide, via the data network interface, the predefined directions specific data to the at least one user in accordance with access parameters, including in relation to the predefined directions data.

The processor is controlled by the computer program code to allow the secure storage means to be made off-line. The processor can be further controlled by the computer program code to connect with the secure storage means 355 by USB and able to be disconnected and made usable off-line.

In FIG. 7 the secure storage means 355 can be fitted to a USB connector 350 which itself communicate through the network 310 back to the server 170 of the trusted adviser 14A, 14B or 14C. However in FIG. 8 the secure storage means 355 is fitted directly to a USB the connector 350 forming part of the server 170 of the system controller and connected directly to the bus to be controlled by the processor 110.

However another substantial advantage is that the processor can be further controlled by the computer program code to allow the secure storage means to be made to stay off-line. In particular the essential life data is stored on the secure storage device 355 including an amount of the software which allows the essential data to be viewed. In this way the secure storage device 355 further acts as a surrogate hard-drive and therefore instructs a connected device 170 to display 210 the essential life data without retaining such data or software on the displaying device 170. In this way the data and software is never traceable online as it has remained off-line except for a diversion to a display device 210.

Clearly the displaying device 170 can use its storage means and software to provide ancillary assistance to the activity of displaying the essential life data from the life essential key 355 without retaining such data or software on the displaying device 170. This can take the form of providing visual formats that create blank precedents that can be in-filled with the data according to the software on the secure storage device 355 without the data or software needing to be included into the displaying device 170. In this way full off-line protection is achieved still having online communication and display.

It can be seen therefore that the essential life data system is a software application technology system which creates a process that has not been possible before to secure private data while ensuring it can be retrieved when necessary if the user dies or is incapacitated. The technology is a software application that secures a user's personal data and documents on a standalone data key (USB) device.

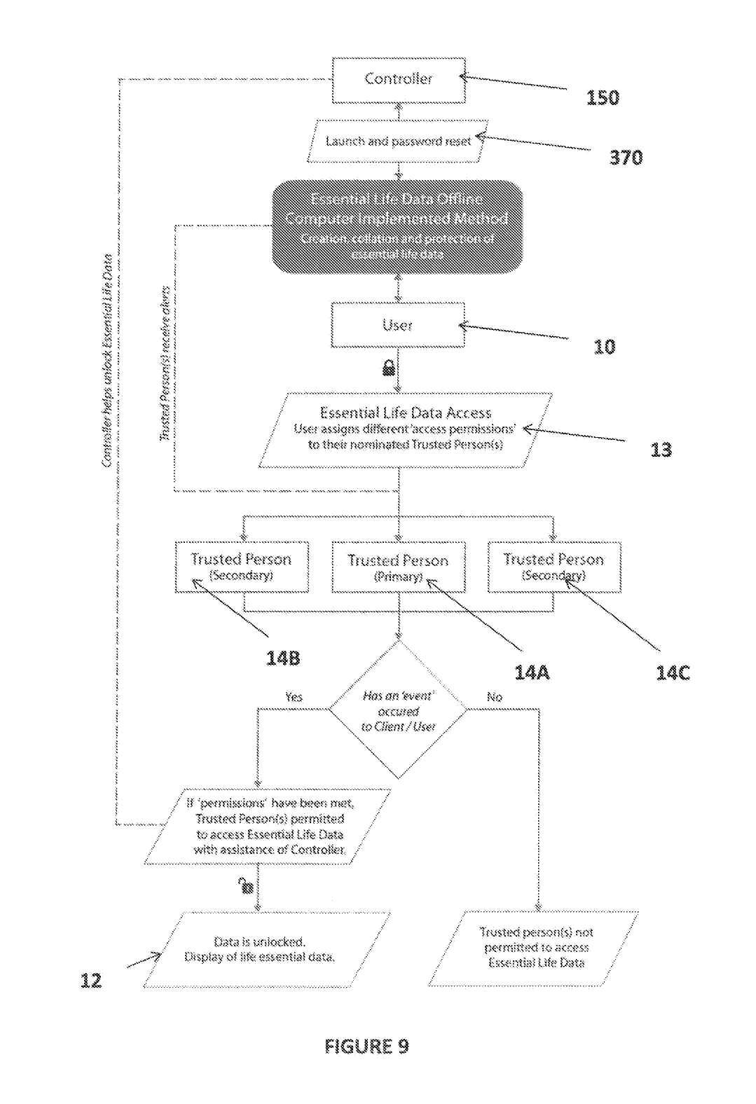

As shown in FIG. 9 the fees system controller 150 can reset password 370 of the essential life data off-line for the creation collection and protection of essential life data of the user 10. A lock applies to therefore create an essential life data access 13 in which the user assigns different access permissions to the nominated trusted persons 14A, 14B or 14C. As the permissions can be limited by particular events at first element in the essential life data access birthday is whether an event has occurred to the user 10. If not access is not available. If the event has occurred in the next element of the commission's need to be met so that the trusted persons 14A, 14B or 14C or one or other of the trust persons 14A. 14B or 14C or all of the trust of persons in combination can have the data unlocked and allow to be displayed in the display of life essential data 12.

As shown in FIG. 6 after the life essential data has been created and collated organised and store on the safe secure system—the application is designed to use most of its functionality OFFLINE—with no cloud or server based storage. Storage is done only on the data key USB and (if the user chooses) via password protected backup files that are encrypted with the native programs algorithms and can only be opened by the native application with the correct password. The application has built in security protocols which also advise and alert the user in a variety of ways to ensure the data entered by the user remains private and secure and will not be exposed accidently.

The software, through the system controller, links the user via the data key USB device to their trusted advisor (via the advisors separate web based interface and/or their own standalone advisor version of the application). The software links the also to a nominated network of trusted person's that the user self identifies using the system process—and connects to via the function and process of the software application (using inbuilt email or inbuilt printed communications and or other forms of communication). The software then automates communications to this network (on a time scale and frequency selected by the user or by the application) to ensure they are aware of the key access information required and launch (password plus email plus application licence key) for the essential life data system software.

When the user dies, or is incapacitated, the advisor and the trusted person network can work together—using the permission protocols granted by the user—to access the important data and documents and files contained within the essential life data system data key and or the backup file created.

The advisor version of the application can read a user's file and can interact with it and or store it based on certain permissions created by the user and/or advisor.

This can only ever store one master file per client—to avoid confusion and issues related to having of duplicate files with conflicting information.

The essential life data system the key software and back end management software is both a jointly hosted and non-hosted platform designed to:
Legally identify, then collect and protect every important personal detail, document and critical life matter that will be needed in the future via proprietary software that can work on a number of dedicated and/or agnostic external storage devices called ‘keys’.
The proprietary software importantly will also ensure that an individual's irreplaceable data can be detected, located, retrieved and managed only by nominated trusted person(s) when required with specific permissions on how it can be dealt with

The essential life data system proprietary software can turn any predetermined external device (i.e. USB drive) into a password protected device that when successfully launched, opens up to a simple yet powerful user interface featuring functions to identify, store and encrypt every important personal detail and document and file related to the legal protection of an individual.

In the essential life data system the key software features:
User friendly. Simple, straight forward and easy to use
Legally developed. The most comprehensive personal data collection & protection available.
Safe. All data is encrypted and secured onto the essential life data system key (nowhere else).
Off the grid. Does not use cloud storage, or web, online storage of any user entered data.
Automates the networking process. Keeps user trusted person network in the loop and connected to the essential life data system with automated communications and updates ensuring it can be recovered when needed.
Generates status reports. Directly sends detailed, time stamped reports of all usage and completion status to any one the user's chooses.
Full privacy controls. User may ‘hide’ full sections of very private data (i.e. passwords, will etc.).
PC and Mac compatible with mobile and tablet interface options
Full, minimum character password protection with user password reset option
Automatic encryption upon data entry
Name, user health status and user predefined event status stamps every user entry
Auto saves all data entered
Allows for multiple encrypted back-up file copies (in case of loss or damage of essential life data system Key)
Allows for hard copy backups via print out option for physical data backup.
Explore Function option enabling user to explore predetermined, hosted web based content within the privacy of the app. All web content can be controlled or created by an advisor. Content can be used to drive client to different areas of interest, related information or to affiliated business.
Impossible to copy or to pirate—without an activation key generated by the interconnected back-end system.
Uses web and or email and or FTP to transfer encrypted files only (not to store any data).

Though the essential life data system Key software is designed to be used as a standalone personal storage and management system for an individual “user”—the functionality of the software on the key is intrinsically linked back to a fully interactive, back end management and control system and interface designed for a “master user.”

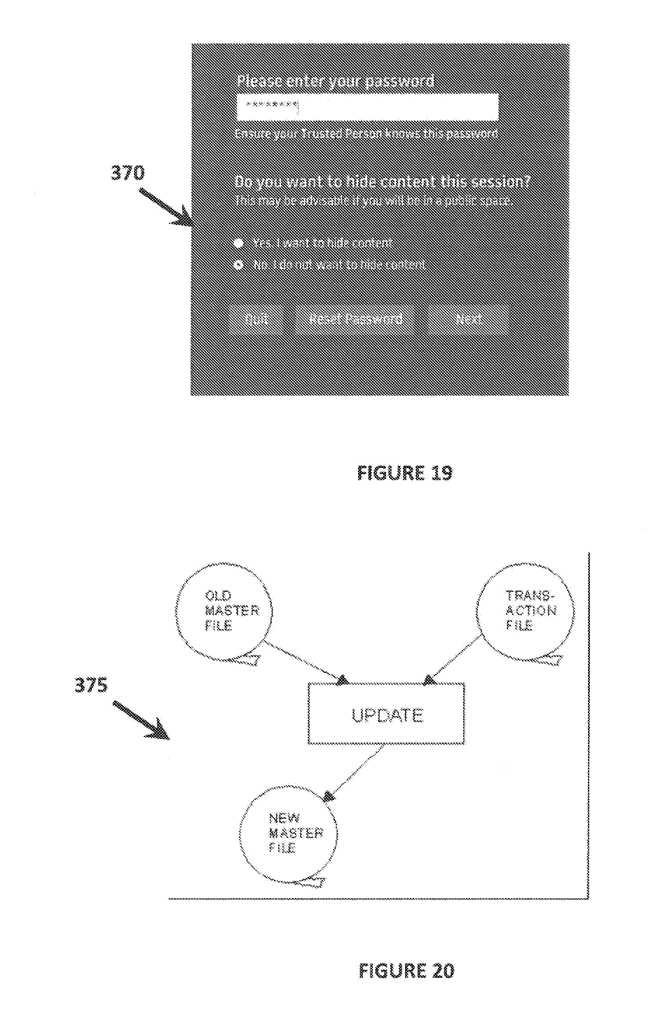

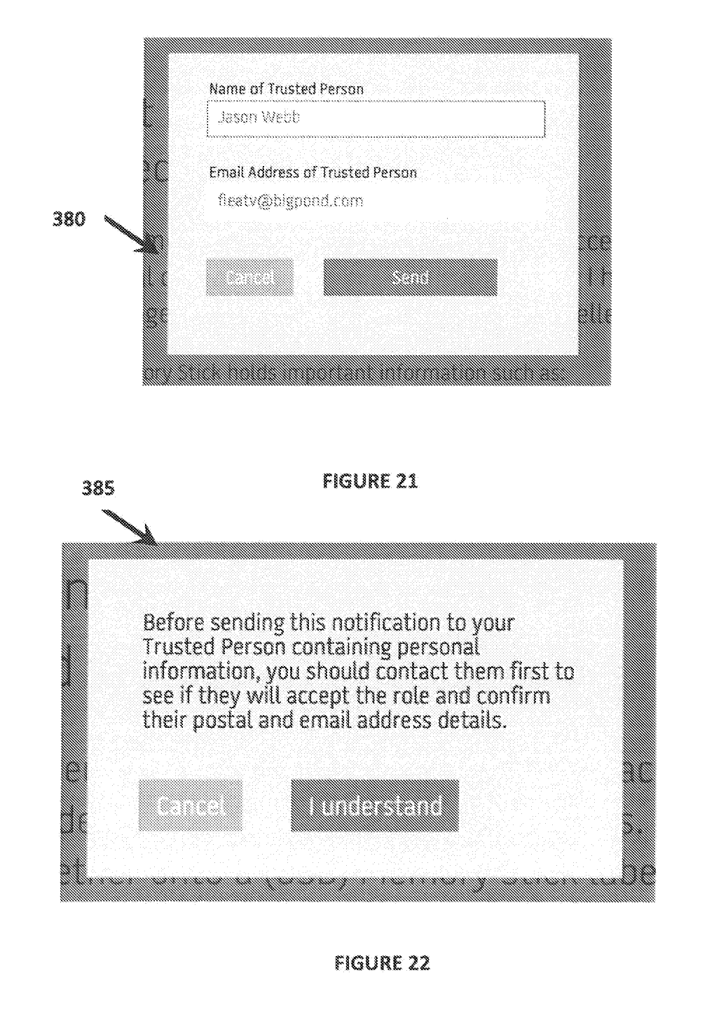

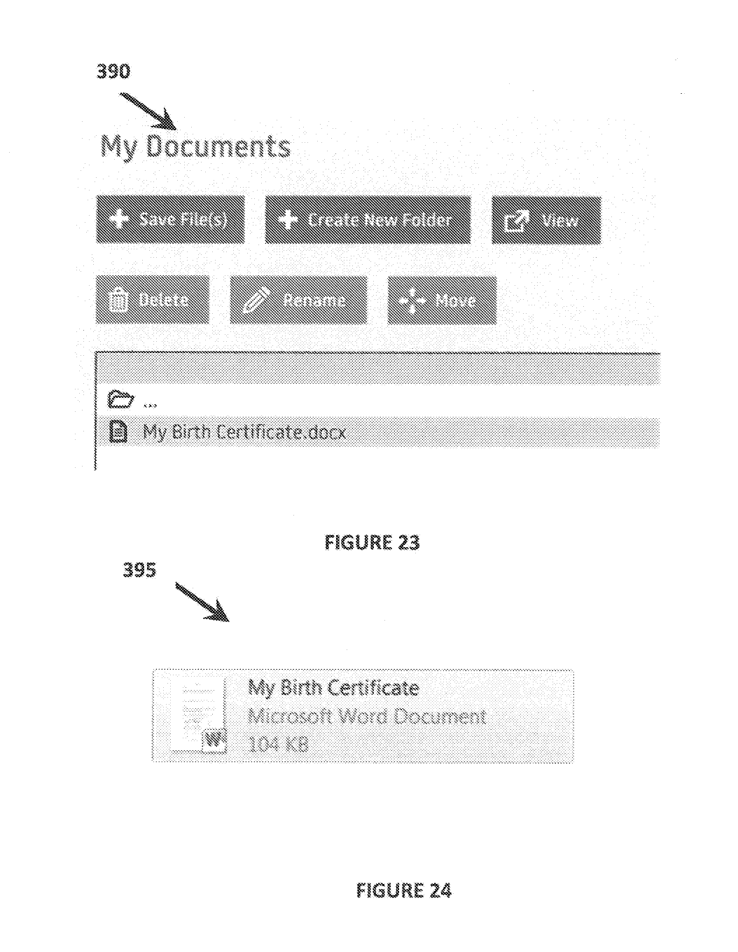

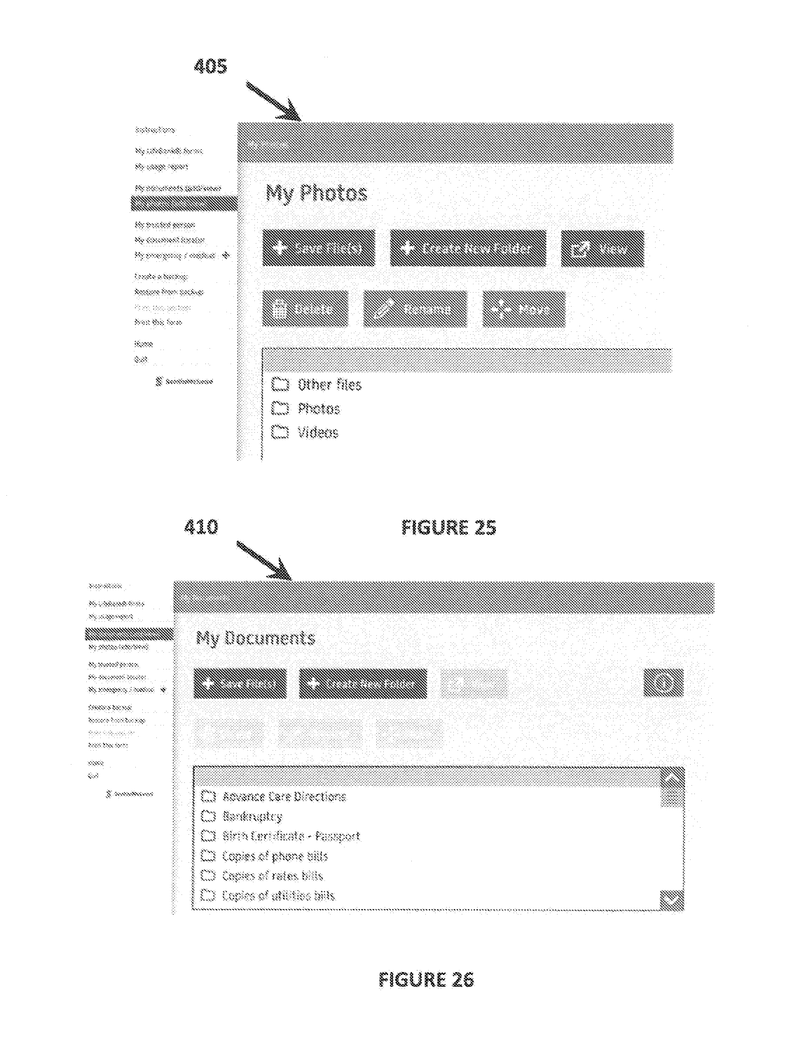

Referring to FIGS. 19 and 20 the essential life data system allows a master user (e.g. a trusted advisor) to activate and/or launch and/or manage the essential life data system Key on behalf of a user (client) without compromising the intrinsic privacy of their client's (user) personal details.
Incorporates a web based management tool for automatic password reset option for clients.
Create additional content for the essential life data system Key
provide optional file external storage and management for the users encrypted essential life data system file.
Allows master user to view, update, manage, edit, return send and store any encrypted essential life data system files sent to them by a (user) client from their essential life data system Key.
Includes import and file sending of client files.
Name and time stamps all advisor interactions with any client's file
Sends automatic email communications to clients re important dates and updates etc.
Helps manage client's Trusted Person network with automatic email and data updates
Creates CRM data population fields from essential life data system Key usage report
Allows a master user to remotely ‘lock out’ or ‘freeze’ access to an individual client's essential life data system key/file (so it cannot be viewed or used or accessed by other parties).
A visual dashboard that generates user statistics, graphs, trends etc.
Multi-platform functionality
Allows filing and storage of all client files.
Stores and links together user details and user document files sent from essential life data system key.
Employs web and or email and or FTP to transfer encrypted files between essential life data system Key and back-end management and control software.

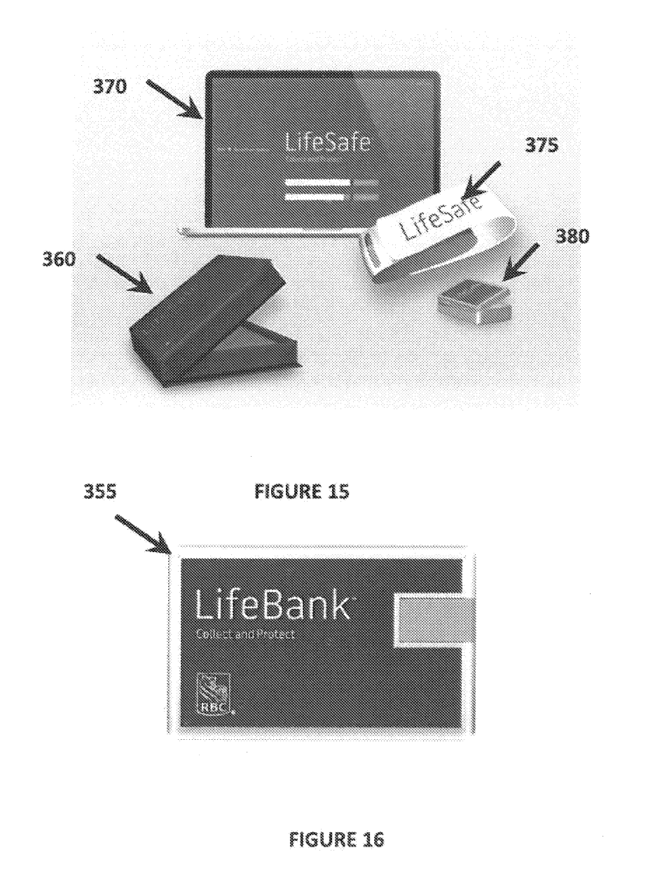

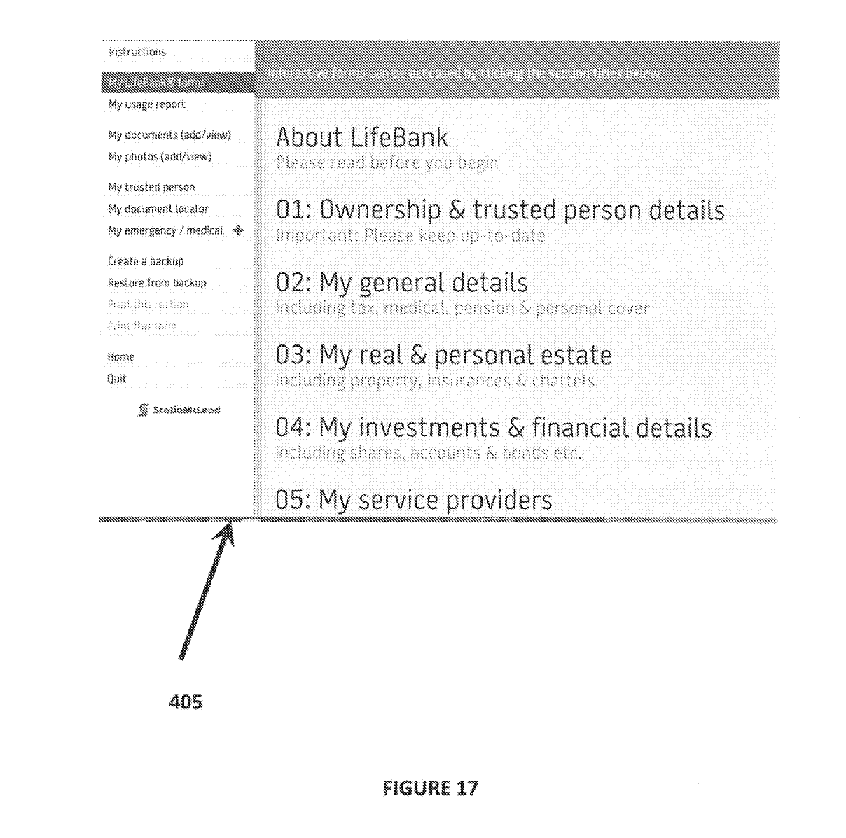

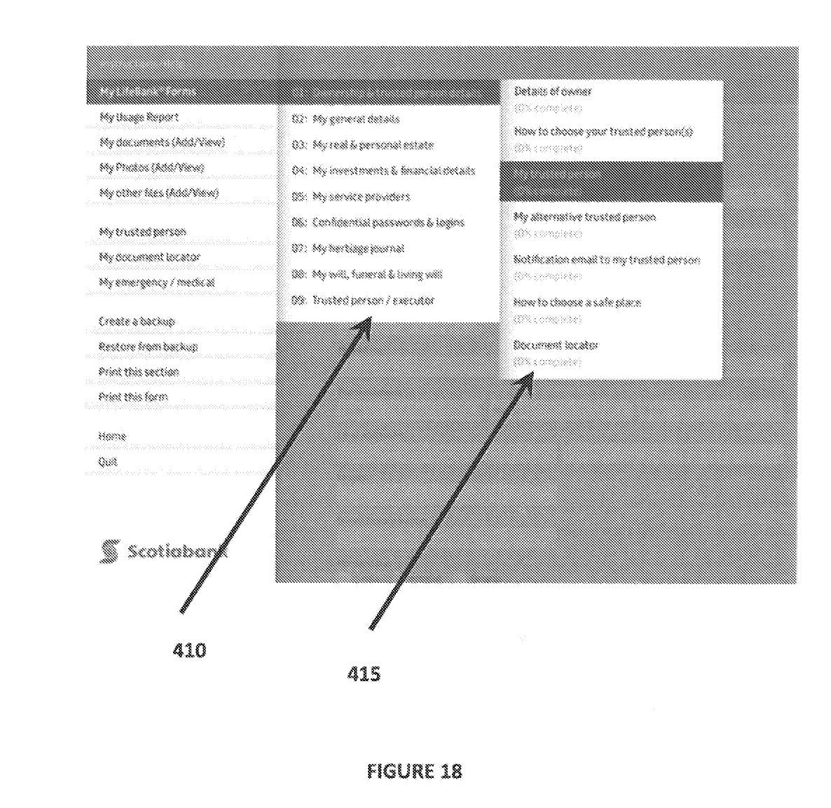

Referring to FIG. 2, the essential life data system includes the correlation of the (non-hosted) private data storage of the essential life data system key 355 and its interaction with the (hosted) back end management software and master user interface. Referring to FIGS. 15 and 16 there are shown the elements of the life essential data system including the access computer 370 of the user who can interact with the systems control and 50 and according to the instructions 360 collate and instruct connections in order to electronically collate and collect a range of life essential documents to form the life essential data. This data can be collected in a controlled means as instructed by the system controller 150 when the life essential key 355 which has a USB connection is actually connected online through the user's computer 370 of the system controller 150. Such life essential key 355 can then be stored in secure weather resistant container 380 and placed in an off-line secure location. This location is included within the system controller records 150.

Essential life data system (also known as essential life data system is a software application/technology system and printed system that creates new processes of securing private data and ensuring a number of mechanisms for it to be retrieved when/if necessary (i.e. if the user dies or is incapacitated) via automated and semi-automated functions of the software application and accompanying human processes it creates.

The technology is a software application that secures a user's personal data and documents on a standalone data key (USB) device.

It uses 4 technical levels of security—
encryption,
password,
registered email plus
an algorithmically created Application Licence Key

The software on the device uses native encryption and also allows the user to create a unique multi-character password protection, linked to a live email account—to secure the application. After launch of the software—the application is designed to use most of its functionality OFFLINE—with no cloud or server based storage.

Storage of all data is done only on the data key USB and (if the user chooses) via password protected backup files that are encrypted with the native programs algorithms and can only be opened by the native application with the correct password.

The application has built in security protocols (checks email addresses and validates user entered email addresses, does not store any info on remote servers or computers or devices) and also alerts/advises the user in a variety of ways to ensure the data entered by the user remains private and secure and will not be exposed accidently.

The software links the user via the data key USB device to their trusted advisor (via the advisors separate web based interface and/or their own standalone advisor version of the application)

The software links also to a nominated network of trusted person's that the user self identifies using the system process—and connects to via the function and process of the software application (using inbuilt email or inbuilt printed communications and or other forms of communication).

The software then automates communications to this network (on a time scale and frequency selected by the user or by the application) to ensure they are aware of the key access information required and launch (password plus email plus application licence key) for the essential life data system software.

When the user dies, or is incapacitated, the advisor and the trusted person network can work together—using the permission protocols granted by the user—to access the important data and documents and files contained within the essential life data system data key and or the backup file created.

The advisor version of the application can read a user's file and can interact with it and or store it based on certain permissions created by the user and/or advisor.

This can only ever store one master file per client—to avoid confusion and issues related to having of duplicate files with conflicting information.

User essential life data system memory stick app is the only resource of its kind. It is a legally designed solution to an expensive problem that everyone ultimately faces. If something happened to user, how would anyone be able to find all of user important details and documents? The essential life data system memory stick solves this issue simply and ingeniously. It collects and protects all of user essential details and documents together, and ensures that only user most trusted person will have access to them when needed. This memory stick could literally save user and user loved ones countless thousands in advisor fees and expenses. It will also save unnecessary anguish (and time) for those charged with having to take over user life affairs. It may also save user life, if users are confronted with a medical or health related emergency condition.

Safe from internet or cloud exposure. The data user enters into the essential life data system memory stick which stays only on the memory stick. This means user can take it anywhere and use it anywhere, and even update user computer without losing user important information. Importantly, it does not store ANY of user information on the internet or cloud. So user safely maintains complete control over user valuable data.

### Key Features Overview

Legally developed. Tells user exactly what critical details and documents user need to save
Collects and protects user important files directly and discreetly onto the memory stick
Fully interactive. Easy to use interface
Safely keeps all of user data off the internet or cloud
Copy protected. Does not work if copied to any other device without

### Activation Key

Allows for unlimited users—perfect for the whole family
Very easy to update user files
Automatically saves user data
Allows user to print out hard copy backups
Features an Emergency condition/medical button in case of an emergency condition
Name, user health status and user predefined event status stamps user information page/form
Large clear visible text
Suitable for mac and pc
Password protection (only on some versions).
   How to launch and register user essential life data system memory stick
Connect the essential life data system memory stick (USB) to a mac or pc computer
Locate the memory stick on user computer (titled either USB or essential life data system).
Click on it and open it to reveal two icons:
   one icon opens the mac version (.app)
   the other icon opens the pc version (.exe)
Click the version that will work on user computer and the app will launch.
A screen will now open for user and ask user to register (if user have not done so already).

After user has received an email with user Activation License Key—enter it here (with user registered email address). Read the licence terms. Click the ‘Agree and submit’ button at bottom of page to activate user memory stick. A new ‘Home screen’ will now open.

The essential life data system forms opens up one of the most important functions of the memory stick—the index of sections containing 85 fully interactive fill-in forms. These important forms will be used to save all of user critical personal details and information. They also provide user with important legal Quick Tips.

The usage report button allows user to create a simple report showing exactly what user have completed, and what remains to be completed. The report can either be printed or emailed to help user send updates of user progress to user professional Advisors.

The documents (add/view) button allows user to save copies of user essential documents and store them in pre-labelled folders (i.e. user Will, Insurances, bank statements plus more).

The photos (add/view) button allows user to add and view all of user important photos to the memory stick.

The trusted person button has important resources and information to help user most trusted person deal with user essential life data system file if something were to happen to user.

The document locator button tells user exactly which documents (i.e. user Will. LifeInsurance etc.) user need to keep safe and where they will be stored (if not on the memory stick). It is ideal for those who do not wish to save their documents onto the memory stick (so user trusted person can find them when needed).

The emergency condition/medical button provides user, (or someone user trust) with instant access to user health and medical details in the case of an emergency condition.

Create a backup button creates an encrypted zip file of all user personal details, documents, photos and other files using this function by selecting a location on user computer to save the backup files to restore from backup button. This allows user to restore user info saved in the Backup file. The Backup file scan only be read using a essential life data system memory stick. The Backup files will replace all current data on the memory stick.

Print this section button allows user to print out an entire section of forms as a hard copy. (including all text entered). These hard copies may be used as a backup or can be provided to user trusted person for safekeeping.

Print this form button allows user to print a single page as a hard copy. This hard copy may be used as a physical backup or provided to user trusted person for safe keeping.

Return to home button takes user back to the main screen where user can select a new user name, enter a new user name, delete an existing user name or view/print out instructions.

Quit button exits user out of the entire essential life data system memory stick application

The essential life data system forms requires the user to do the following:

Enter user important details onto the memory stick here.

The essential life data system application opens up on the The essential life data system forms button automatically.

Familiarise user with the main menu side-bar buttons.
Use the scroll bar on the right hand side to reveal all of the section titles.
Click on each section title to reveal a sub menu of interactive forms and information pages. Interactive forms have an arrow icon beside them. Information pages have no arrow.
Each form contains important questions for user to answer and features interactive text fields for user to fill in.
Complete these fields as best as user can, with as much detail as user can afford. The text fields expand, so user will not run out of room.
Any information user enter into these text fields is automatically saved when user leave the form.
The information user disclose on these forms should only be accessed by user, or by a trusted person that user have nominated (if/when needed in the future).
User need only fill out forms and fields that pertain to user situation.

### N/A Button

If any information requested of user on a form does not pertain to user, simply hover user mouse on the right hand side of the ‘Question line’ and user will see a N/A (not applicable) button appear.

Click on this button and the line will auto-fill with ‘Not applicable.’ Do this instead of leaving the line blank so that user trusted person will know that this category does not apply to user.

Complete the sections (as user please)

Click on each section title to browse its content and interactive forms.

Not all sections have interactive content to fill-in; some are text only (such as ‘Section 1’ and ‘Section 9’). Some will be easy for user to complete immediately, others may require user to find the details and/or discuss with certain parties if it affects them (such as Section 0: ‘Important’).

Completion of forms should be as thorough as possible as just one missing detail can lead to significant problems later for user or user family. Take user time! User does not have to complete all of the forms in one sitting; in fact, it may take user a number of sittings to complete them. Some will take careful consideration (such as the Living Will). Others forms will take research or family consultation (such as the Heritage/Legacy Journal)

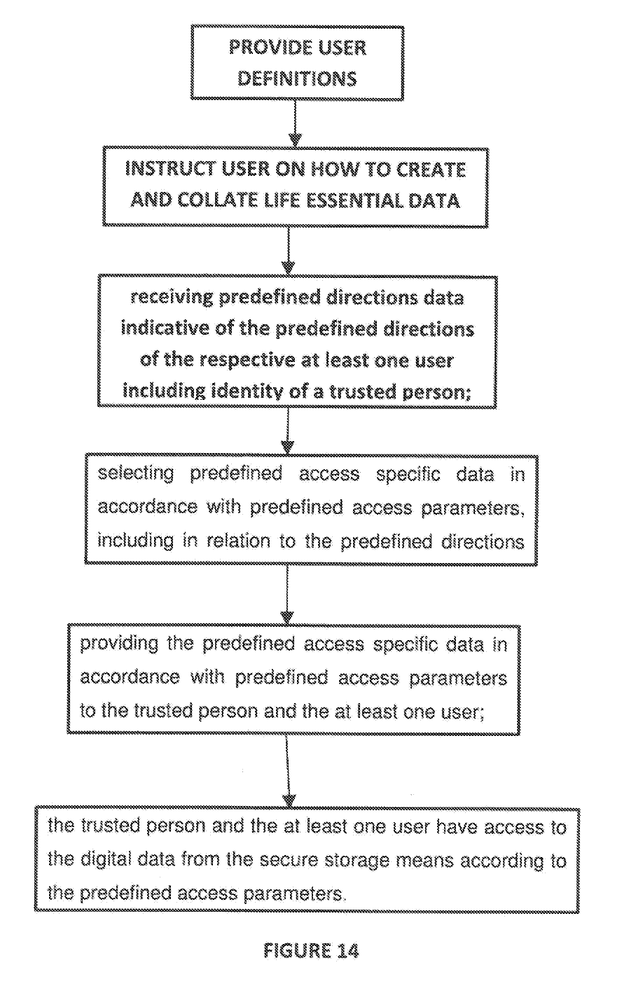

FIG. 14 shows a computer implemented method 300 for controlling essential life data including estate content to users according to their predefined directions. The method 300 is executed by one or more computing devices 100, and in particular one or more computing devices 220 connected into a data network, as substantially shown in FIGS. 6 to 8. There is shown a computer-implemented method for controlling essential life data including estate content to at least one user according to the respective user's predefined directions, the computer-implemented method comprising:
receiving essential life data including estate content and recording as digital data;
providing a secure digital storage means for receiving and storing the digital data;
receiving predefined directions data indicative of the predefined directions of the respective at least one user including identity of a trusted person;
selecting predefined access specific data in accordance with predefined access parameters, including in relation to the predefined directions data
providing the predefined access specific data in accordance with predefined access parameters to the trusted person and the at least one user;
wherein the trusted person and the at least one user have access to the digital data from the secure storage means according to the predefined access parameters.

The secure storage means is able to be made off-line by being connectable by USB and able to be disconnected and made off-line wherein the secure storage means is storable in a secure remote location.

There is included a digital key wherein the digital key provides the predefined access specific data in accordance with predefined access parameters. The computer-implemented method has the secure storage means being also the digital key.

The computer-implemented method 300 starts at step 310, where the server 21t is adapted to receive predefined directions data indicative of the real time predefined directions of a user. The real time predefined directions of the user may be determined via any one of a number of ways. In one embodiment, the predefined directions data corresponding to the predefined directions of the user is received from the predefined directions access key.

As per step 340 the predefined directions specific data is made available according to the access parameters including the predefined directions data to the at least one users.

### Interpretation

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In accordance with:

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’. ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database:

In the context of this document, the term “database” and its derivatives may be used to describe a single database, a set of databases, a system of databases or the like. It can also be used to include a “lookup table” or something similar that is more of a static database. This can be on a remote server or on a user portable device. The system of databases may comprise a set of databases wherein the set of databases may be stored on a single implementation or span across multiple implementations. The term “database” is also not limited to refer to a certain database format rather may refer to any database format. For example, database formats may include TheSQL, TheSQLi, XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the advertising industry.

1.-82. (canceled)

83. A computer-implemented method for controlling essential life data including estate content to at least one user according to the respective user's predefined directions, the computer-implemented method comprising:
a. receiving essential life data including estate content, and recording as digital data;
b. providing a secure digital storage means for receiving and storing the digital data;
c. receiving predefined directions data indicative of the predefined directions of the respective at least one user including identity of a trusted person;
d. selecting predefined access specific data in accordance with predefined access parameters, including in relation to the predefined directions data;
e. providing the predefined access specific data in accordance with predefined access parameters to the trusted person and the at least one user; and
f. wherein the trusted person and the at least one user have access to the digital data from the secure storage means according to the predefined access parameters.

84. A computer-implemented method as claimed in claim 83, wherein the secure storage means is able to be made off-line.

85. A computer-implemented method as claimed in claim 83, wherein the secure storage means is connectable by USB and able to be disconnected and made off-line.

86. A computer-implemented method as claimed in claim 83, wherein the secure storage means is storable in a secure remote location.

87. A computer-implemented method as claimed in claim 83, including a digital key wherein the digital key provides the predefined access specific data in accordance with predefined access parameters.

88. A computer-implemented method as claimed in claim 87, wherein the secure storage means is also the digital key.

89. A computer-implemented method as claimed in claim 83, including software, which allows the essential data to be viewed, is also stored on the secure storage device and acts as a surrogate hard drive forming a standalone platform to drive the display of essential data.

90. A computer-implemented method as claimed in claim 89, wherein the software is operable only on receipt of the life essential, data key including the password and e-mail identification.

91. A computer-implemented method as claimed in claim 90, wherein data and key files are hidden in the matrix of the software application and extractable only with the password, the email ID and access to the software on the standalone platform on the essential data secure digital storage means.

92. A computer-implemented method as claimed in claim 91, wherein the essential life data and software remain off-line to a device's processor or memory even when using a remote display of the device.

93. A computer-implemented method as claimed in claim 83, wherein the access parameters include, in relation to the predefined directions data, a combination of one or more access parameters including user health status and user predefined event status.

94. A computer-implemented method as claimed in claim 93, wherein access parameters include, in relation to the predefined directions data, a combination with one or more other access parameters including identification of trusted person data, wherein a modified predefined directions specific data is available.

95. A computer-implemented method as claimed in claim 83, further comprising: making available the predefined directions specific data to the at least one user or trusted person according to the access parameters including the predefined directions data.

96. A computer-implemented method for controlling essential life data including estate content of at least one user according to the respective user's predefined directions, the computer-implemented method comprising:
a. receiving essential life data, including estate content and recording as digital data;
b. receiving predefined directions data, indicative of the predefined directions of the respective at least one user, including identity of a trusted person;
c. selecting predefined access specific data, in accordance with predefined access parameters, including in relation to the predefined directions data;
d. providing a secure digital storage means which;
i. receives and stores the digital data;
ii. includes software adapted to include predefined access parameters, which allows the essential life data to be viewed, and is also stored on the secure storage device and acts as a surrogate hard drive forming a standalone platform to drive the display of essential life data;
e. providing the predefined access specific data, in accordance with predefined access parameters, to the trusted person and the at least one user; and
f. providing a digital key, wherein the digital key provides the predefined access specific data in accordance with predefined access parameters;
wherein the secure storage means is able to be made off-line, and wherein the trusted person and the at least one user have access to the digital data from the secure storage means according to the predefined access parameters, and wherein the software is operable only on receipt of the digital key.

97. A computer-implemented method as claimed in claim 96, wherein the secure storage means is connectable by USB and able to be disconnected and made off-line.

98. A computer-implemented method as claimed in claim 96, further comprising: the life essential data of personal information comprising important information and documents relating to the person's assets and how these assets should be distributed in the case of incapacitation, death or disappearance, including important information and documents relating to the person's will, related powers of attorney, account details, insurance policies, broker accounts, property deeds, mortgages or other related information or documents.
